(19) United States
(12) Patent Application Publication
(10) Pub. No.: US 2022/0010395 A1
(43) Pub. Date: Jan. 13, 2022

(54) HIGH SURFACE COMPRESSIVE STRESS FOR THROUGH HARDENING

(71) Applicant: The Timken Company, North Canton, OH (US)

(72) Inventor: Mohan Chand Paladugu, Canton, OH (US)

(21) Appl. No.: 17/291,861

(22) PCT Filed: Apr. 12, 2019
(86) PCT No.: PCT/US2019/027343

§ 371 Date: May 6, 2021

Related U.S. Application Data
(60) Provisional application No. 62/769,313, filed on Nov. 19, 2018.

(51) Int. Cl. C21D 9/40; C21D 1/20; C21D 1/78; C21D 9/36

(52) U.S. Cl. CPC C21D 9/40; C21D 1/20; C21D 1/785; C21D 2211/008; C21D 2211/001; C21D 2211/002; C21D 9/36

(57) ABSTRACT

A heat treatment process for through hardening results in high surface compressive stresses. The method includes heating a steel component to a first temperature, quenching the steel component to a second temperature, maintaining the steel component at the second temperature for a first duration of time, heating the steel component to a third temperature, maintaining the steel component at the third temperature for a second duration of time, and quenching the steel component to a fourth temperature when austenite to martensite+bainite or bainite transformation is at least 10% but less than 85% complete.

### RELATED APPLICATIONS

This application claims priority to co-pending U.S. Provisional Patent Application No. 62/769,313 filed on Nov. 19, 2018, the entire contents of which is incorporated herein by reference.

The present invention relates to through hardening steel components, and more particularly to methods to achieve high surface compressive stress in through hardened steel components and the components through hardened using such methods.

### BACKGROUND

Through hardening is a heat treatment process that includes heating a steel component to a high temperature during an austenitizing step to change the microstructure of the steel to a pure austenite microstructure. The austenitizing process may include one or more heating cycles or one or more austenitization cycles. The component is then rapidly quenched to increase a hardness throughout a steel component, which increases the strength of the component. Different quench mediums include forced air or gas, still air or gas, quench oil, water and a liquid salt. The component may be quenched to a temperature, such as approximately to a martensite start temperature (T_{MS}), which enables further transformation of the microstructure of the component. For example, the microstructure can be transformed from austenite to martensite, bainite, pearlite, or a combination of these microstructures. Additionally, the component may be tempered after the component is quenched by re-heating the component to decrease a brittleness of the component.

### SUMMARY

The present invention provides, in one aspect, a method for heat treating steel. The method includes heating a steel component to a first temperature, quenching the steel component to a second temperature, maintaining the steel component at the second temperature for a first duration of time, heating the steel component to a third temperature, maintaining the steel component at the third temperature for a second duration of time, and quenching the steel component to a fourth temperature when a fraction of bainite or martensite+bainite is at least 10%, but not more than 85%. Preferably, the fraction of bainite or martensite+bainite is between 20% and 65%.

The present invention provides, in another aspect, a steel component. The steel component includes a microstructure of the steel component including at least 15% retained austenite throughout the steel component. The surface region has a residual compressive stress of at least 100 MPa, and a hardness throughout the steel component is at least 50 HRC. In some cases, the phase transformation process outlined produces a non-uniform microstructure between the case and core of the component which includes at least 30% bainite in the core of the steel component and at least 30% martensite in surface region of the steel component.

Other features and aspects of the invention will become apparent by consideration of the following detailed description and accompanying drawings.

### BRIEF DESCRIPTION OF THE DRAWINGS

FIG. 1 is a time-temperature-transformation chart of the austenite to bainite or martensite+bainite conversion in various stages.

FIGS. 2A-2D depict example components that have been heat treated using the method described herein.

FIG. 3 is an alternative time-temperature-transformation chart of the austenite to bainite or martensite+bainite conversion in various stages.

FIGS. 4 and 5 are time-temperature-transformation charts that may be used austenitizing a component.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

The present invention is related to a heat treatment process explained using an example of austempering of bearing steel grades, such as 100CrMo7-3 or 100CrMnSi6-4, or any other steel grade having a carbon composition of at least 0.7 weight % (wt %). However, those of ordinary skill in the art would understand that the inventive heat treatment process could be applied to other steels as well. The typical chemical composition of 100CrMo7-3 steel include 0.9 wt % carbon, 0.3 wt % silicon, 0.7 wt % manganese, 1.8wt % chromium, 0.3 wt % molybdenum. The typical chemical composition of 100CrMnSi6-4 steel include 0.9 wt % carbon, 0.6 wt % silicon, 1.1 wt % manganese, 1.5 wt % chromium.

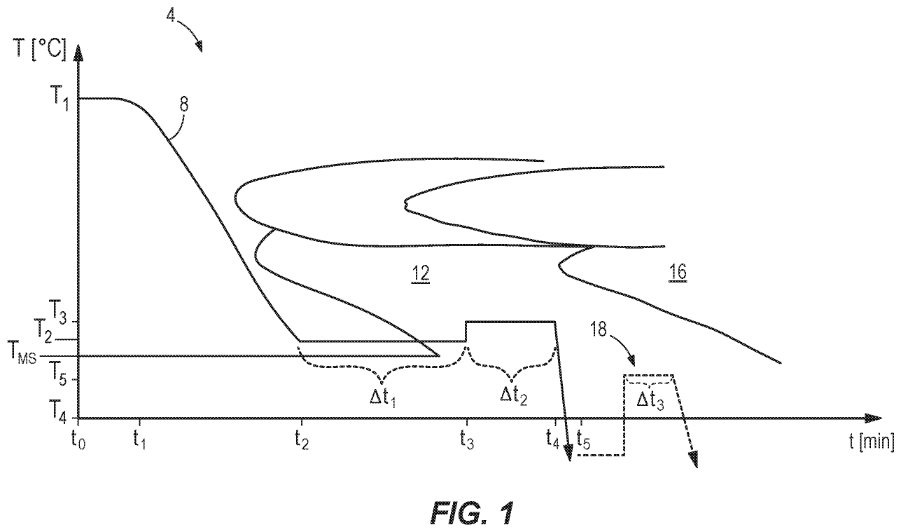

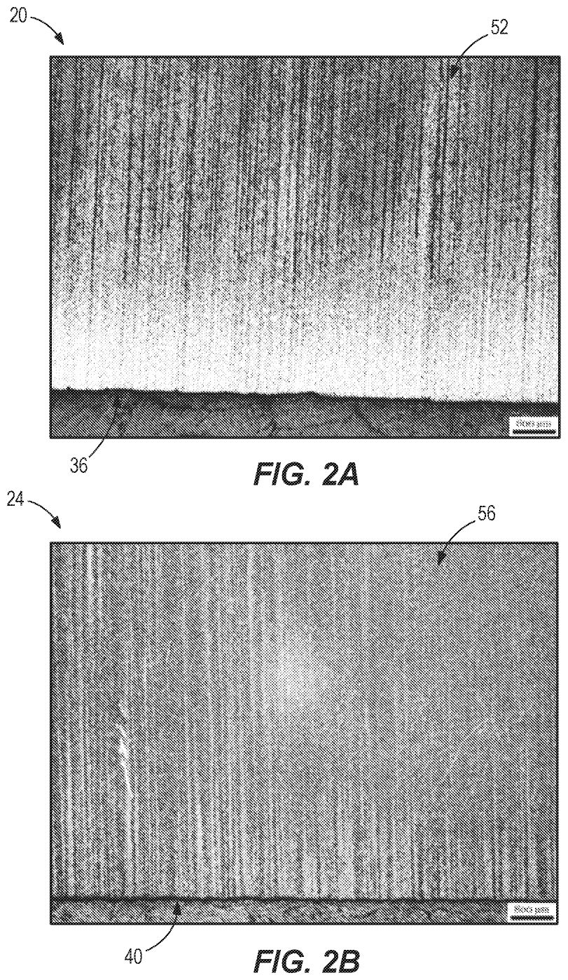

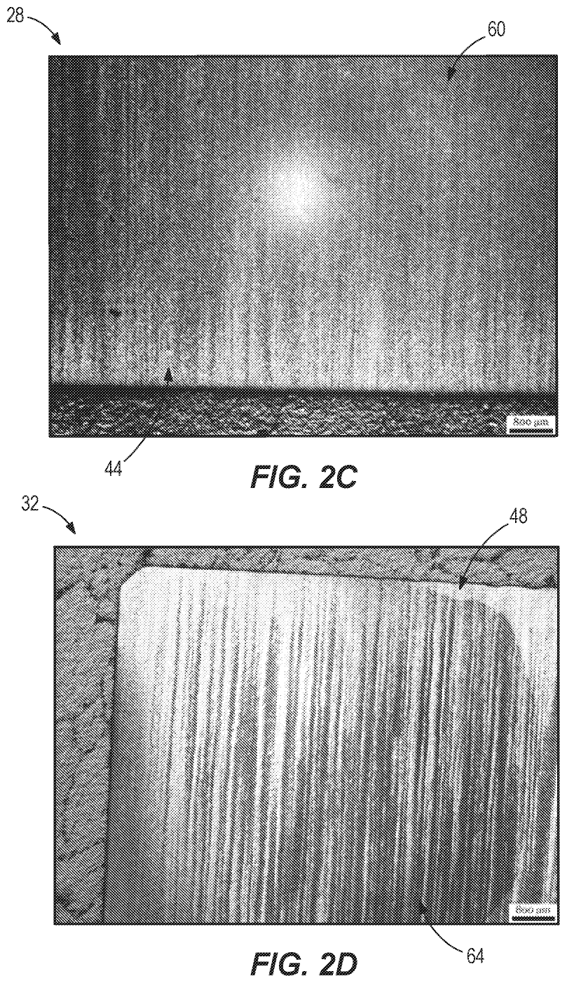

The through hardening process described herein is a dual step austempering of a bearing steel component (e.g., a bearing race or roller, such as a bearing steel component 20, 24, 28, 32 of FIGS. 2A-2D). As shown in FIG. 1, the steel component may first be austenitized throughout its cross section by heating the component to an initial temperature T₁, which in the illustrated embodiment is a temperature from 800 degrees Celsius to 1100 degrees Celsius. To fully austenitize, the component is held at the temperature T₁ for a duration of time 5 minutes to 240 minutes. One or more heating cycles may be used to austenitize the component or one or more austenitizing cycles may be used. After the austenitization is complete and the component has a microstructure of austenite and some carbide particles, the component is then heat treated using the dual step austempering process described herein beginning at an initial time to, which is shown in FIG. 1.

FIG. 1 depicts a time-temperature-transformation (TTT) chart 4 showing a transformation curve 8 of the heat treatment process described herein. Beginning at a time t₁, the component is quenched from the initial temperature T₁ to a temperature T₂ by a time t₂. The temperature T₂ is within a range of a martensite start temperature T_{MS}, such as from 0.6*T_{MS} to 1.4*T_{MS}, but is preferably from 0.9*T_{MS} to 1.4*T_{MS} or from 0.6*T_{MS} to 1.2*T_{MS}. For the example type of bearing steel described herein, T_{MS} is about 180-200 degrees Celsius. The component is held at the temperature T₂ for a time interval Δt₁ from time t₂ to time t₃. The quench and holding medium includes a liquid salt bath or a quench oil bath. The time interval Δt₁ may be any length of time from 20 minutes to 180 minutes, but alternatively may be from 20 minutes to 240 minutes, where T₂ is at or above T_{MS}. The time interval Δt₁ may preferably have a duration of 30 minutes to 120 minutes. If T₂ is less than T_{MS}, Δt₁ may be any time greater than 30 minutes. During the time interval Δt₁, the component is held at temperature T₂, and the microstructure transforms into martensite if the temperature T₂ is at or below the martensite start temperature T_{MS}. The amount of martensite formed is proportional to the difference between T_{MS} and T₂ (T_{MS}−T₂). If T₂ is 0.6*T_{MS}, the amount of martensite formed is about 30 to 40%. In addition some bainite starts to nucleate in proportion to the duration of Δt₁ even below the T_{MS}. If T₂ is at or above T_{MS}, the transformation from austenite to bainite begins when the curve 8 reaches the austenite+bainite region 12 on the TTT chart 4. The amount of microstructure that transforms to bainite at least partially depends on the duration of the time interval Δt₁ for which the component is held at temperature T₃. For example, a component held a T₂ for 30 minutes has a lower amount of bainite than a component held at T₂ for 60 minutes.

At a time t₃, the component is heated to a temperature T₃, which is 5 degrees C. to 200 degrees C. greater than T₂. The heating can be done by transferring the component to another salt bath or a furnace that is held at the temperature T₃. Alternatively, the component can be heated in the same salt bath or furnace by increasing the temperature. The component is held at temperature T₃ for a time interval Δt₂ from time t₃ to time t₄. The time interval Δt₂ may be any length of time from 5 minutes to 600 minutes, but may alternatively be between 5 minutes to 240 minutes in some instances. The time interval Δt₂ may preferably have a duration from 30 minutes to 120 minutes. The amount of microstructure that transforms to bainite at least partially depends on the duration of the time interval Δtₜ for which the component is held at temperature T₃. While the component is held at the temperature T₃, the microstructure of the component continues transformation in the austenite+bainite region 12. However, the second austempering step is interrupted before the curve 8 reaches the bainite region 16 and before complete bainite transformation of the microstructure is achieved. At the time t₄ and the temperature T₃, from 10% to 85% of the austenite in the microstructure is transformed into bainite or martensite+bainite. The transformation from austenite to bainite or martensite+bainite is not a complete transformation and some austenite still remains at time t₄. Preferably, at the time t₄ and the temperature T₃, 20-65% of the austenite will have transformed into bainite or martensite+bainite, leaving 35-80% retained austenite. In some examples, at the time t₄ and the temperature T₃, 20-85% of the austenite will have transformed into bainite or martensite+bainite, leaving 15-80% retained austenite. In other examples, at the time t₄ and the temperature T₃, 20-80% of the austenite will have transformed into bainite or martensite+bainite, leaving 20-80% retained austenite. The dual step austempering process stabilizes the retained austenite in the component. Although only two steps are explained in this embodiment, the transformation process of austenite to bainite or martensite+bainite may include two or more heating and holding steps that are similar to the above explained steps.

At time t₄, the component is quenched to a temperature at or below a room temperature, 100 degrees Celsius, or an ambient temperature. The quench medium includes water, oil, still air or gas, forced air or gas. After quenching, the amount of retained austenite in the near surface area is at least 15%, but is alternatively at least 20%. The components may be tempered after the second quench or may be used without tempering. To temper the steel component, the steel component may be heated to a fifth temperature that is from 100 degrees Celsius to 350 degrees Celsius and quenched to an ambient or room temperature. The hardness of the steel part is at least 50 Rockwell C (HRC) across a cross-section of the component after the quenching at the time t₄ and also after a quench tempering heat treatment after t₄. The quench tempering heat treatment 18 after t₄ can be done to reduce the amount of retained austenite to less than 15% while keeping high compressive surface residual stresses of at least 100 MPa. The quench tempering heat treatment 18 begins at time t₅ and includes heating the component to a temperature T₅ for a short period of time Δt₃, after which the component is again quenched to a temperature at or below a room temperature, 100 degrees Celsius, or an ambient temperature. The quench tempering heat treatment 18 is optional.

The example heat treatment method depicted by the TTT chart 4 with the curve 8 may result in a structure that has a different microstructure composition at a core of the component than at a surface region of the component. For the example types of steel described herein, the core has a microstructure composition of at least 30% bainite, but may alternatively be at least 40% bainite, and the composition may alternatively include at least 50% bainite at the core. The surface region has a composition of at least 30% martensite, and the composition may alternatively be at least 40% martensite, and amount of bainite in the surface region is lesser than that in the core of the component. In some embodiments, the composition may be at least 50% martensite in the surface region. The difference in the microstructure constituents between the core and case regions appear in optical metallographic observations. As used herein and in the appended claims, the surface region is defined as the surface of the component and the subsurface of the component up to a depth of 1000 micrometers below the surface. The different microstructure constituents between the core and case regions significantly appear when austenite to bainite or austenite to martensite+bainite transformation is terminated (at t₄ and T₃) at or below 50% (leaving 50% of austenite at T₃). As a consequence of quenching at t₄, martensite forms in the surface region of the steel component. Typically, austenite to bainite transformation takes place from the core to the surface of the component, and austenite to martensite transformation takes place from the surface to the core of the component. Because of this microstructural transformation difference, a different microstructures arise in the case and the core regions of the component. The different microstructure constituents between the core and the case regions may also be possible when austenite transformation is terminated between 50 to 85%, but the optical metallography methods may not be able to reveal the microstructural difference between the case and core regions.

The resulting microstructure forms a component that has a high residual compressive stress in the surface region. The residual compressive stress is at least 100 Megapascals (MPa) at the surface. The resulting high residual compressive stress at the surface of a bearing component increases the component performance by increasing the fatigue life of the component, thus enabling the components to last longer. In addition, bainite microstructure in the core and martensitic microstructure near the surface could improve fatigue resistance of the steel component.

FIGS. 2A-2D are optical metallographs and depict examples of steel components 20, 24, 28, 32 heat treated using the heat treatment process described herein. The example steel components 20, 24, 28, 32 include 15% to 40% retained austenite in the microstructure. The residual stress at the surface is affected by the percentage of retained austenite and martensite in the microstructure at the surface. As shown in FIGS. 2A-2D, the microstructure composition of the heat treated component 20, 24, 28, 32 is graded such that the microstructure at the surface 36, 40, 44, 48 gradually transforms from at least 30% untempered martensite (appears brighter), but preferably at least 40% untempered martensite, at the surface region 36, 40, 44, 48 to at least 30% bainite (appears darker), but preferably at least 40% bainite, at the core 52, 56, 60, 64 . Moving from the surface region 36, 40, 44, 48 of the component 20, 24, 28, 32 to the core region 52, 56, 60, 64, the steel microstructure appears darker, indicating that more bainite is present in the core region 52, 56, 60, 64. The lighter areas near the surface region 36, 40, 44, 48 are untempered martensite microstructure and some fraction of retained austenite (e.g., less than or equal to 40% retained austenite).

FIG. 2A depicts an example steel component 20 heat treated using the method described herein. In this particular example, at a depth from the surface 36 of 75 micrometers and a quantity of retained austenite of 25.2%, the residual compressive stress is 265.4±9.6 MPa. At a depth of 230 micrometers and a retained austenite quantity of 24.7%, the residual compressive stress is 233.7±12.4 MPa. At a depth of 610 micrometers and a retained austenite quantity of 25.9%, the residual compressive stress is 246.1±13.1 MPa.

FIG. 2B depicts another example of a heat treated component 24 using the method described herein. At a depth from the surface 40 of 75 micrometers and a retained austenite quantity of 30.1%, the residual compressive stress is 270.3±14.5 MPa. At a depth of 230 micrometers and a retained austenite quantity of 28.4%, the residual compressive stress is 447.5±20 MPa.

FIG. 2C depicts another example of a heat treated component 28 using the method described herein. At a depth from the surface 44 of 75 micrometers and a retained austenite quantity of 32.6%, the residual compressive stress is 274.4±12.4 MPa. At a depth of 230 micrometers and a retained austenite quantity of 33.7%, the residual compressive stress is 291±11.7 MPa.

FIG. 2D depicts another example of a heat treated component 32 using the method described herein. At a depth from the surface 48 of 75 micrometers and a retained austenite quantity of 25.4%, the residual compressive stress is 232.3±11.7 MPa. At a depth of 230 micrometers and a retained austenite quantity of 24.6%, the residual compressive stress is 217.9±14.5 MPa. At a depth of 610 micrometers and a retained austenite quantity of 25.6%, the residual compressive stress is 191.6±15.8 MPa.

As shown by the example heat treated components 20, 24, 28, 32 depicted in FIGS. 2A-2D, the compressive residual stress is greater than 100 MPa throughout a surface region 36, 40, 44, 48 of the component for a variety of retained austenite compositions of 15% to 40%.

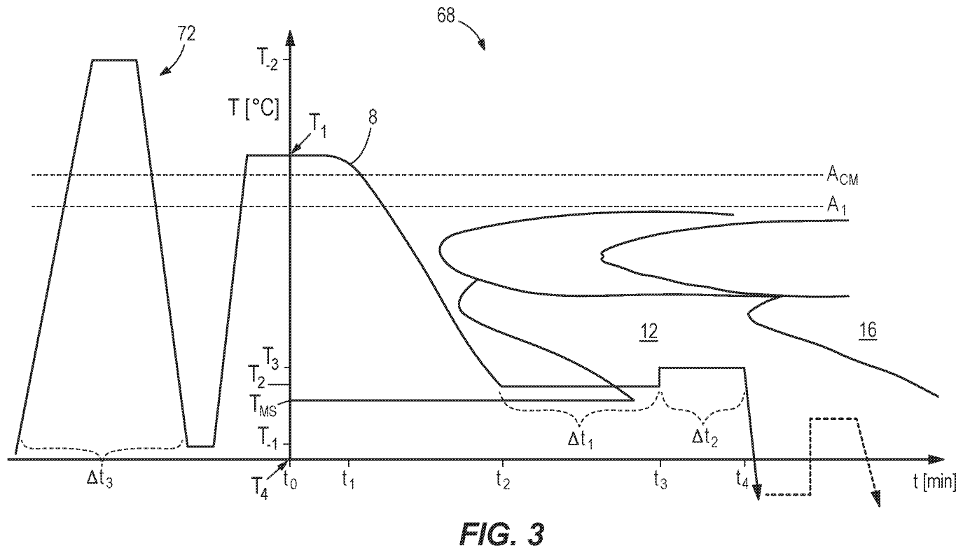

FIG. 3 is an alternative time-temperature-transformation chart 68 of the austenite to bainite or martensite+bainite conversion in various stages. The steel used in the illustrated example is bearing steel grades, such as 100CrMo7-3 or 100CrMnSi6-4, or any other steel having a carbon composition of at least 0.7 wt %. The heat treatment process shown in the alternative time-temperature-transformation chart 68 of FIG. 3 includes an additional heating and quenching cycle 72 that may be added to the heat treatment process 4 described above. In the illustrated example, the component is first heated to a high temperature of T₋₂, which is a carbide dissolution temperature of approximately 900 to 1100 degrees Celsius. This heating stage has a duration Δt₃ of at least 30 minutes. In one example, the duration Δt₃ is from 30 minutes to 300 minutes. The duration Δt₃ is inclusive of the heating time, holding time, and cooling time of the heating stage. The temperature T₋₂ is above the A₁ and the A_{CM} temperatures for the steel component. The A₁ transformation temperature is the temperature at which the ferritic phase of the steel starts to transform into austenite. The A_{CM} temperature is the temperature at which the ferritic phase of the steel is completely transformed into austenite. During this heat treatment stage 72 at least some of the carbides in the component are dissolved. After the heating stage 72, the component is quenched to a temperature T₋₁. The temperature T₋₁ is less than 500 degrees Celsius, but in one embodiment may be less than 300 degrees Celsius.

Next, the component is then reheated a temperature above the A₁ temperature, and may also be above the A_{CM} temperature. The A_{CM} transformation temperature is the temperature at which the ferrite phase of the steel completely transforms into austenite. In the illustrated example, this temperature is the same as the temperature T₁ of the heat treatment cycle described in FIG. 1. Alternatively, the temperature of the second heating stage may be within the range of 750 to 900 degrees Celsius. Following the second heating stage, the heat treatment cycle of FIG. 3 is identical to the heat treatment cycle of FIG. 1. However, the additional heating stage results in components with improved residual compressive stress and refined microstructures. Thus, the heat treatment cycle of FIG. 3 may be better for some applications than the heat treatment cycle of FIG. 1.

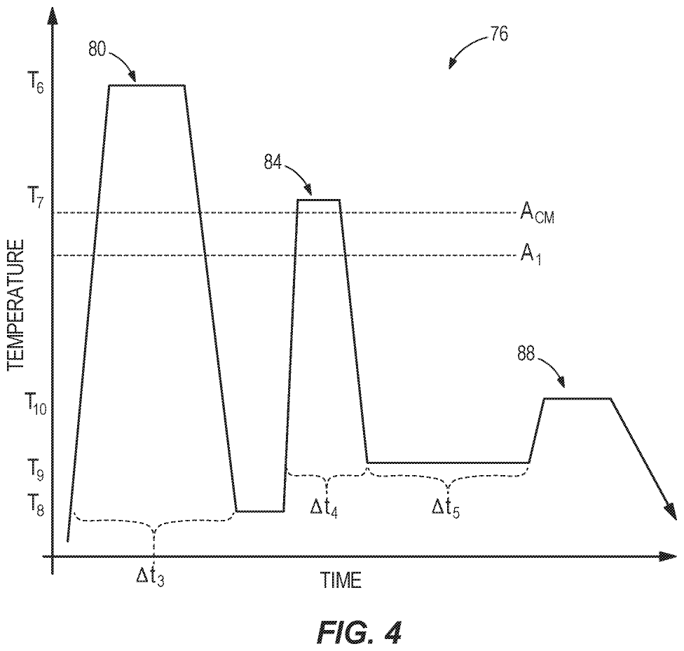

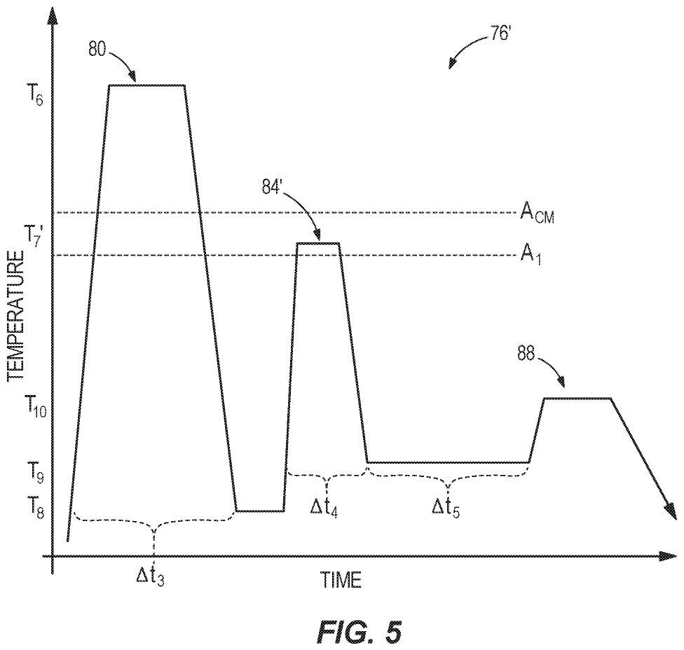

FIGS. 4 and 5 are time-temperature charts 76, 76′ that may be used for austenitizing a component. The steels used in the illustrated example are bearing steel grades, such as 100CrMo7-3 or 100CrMnSi6-4, or any other steel grade having a carbon composition of at least 0.7 wt %. The austenitization cycle contains two or more heating cycles (e.g., austenitization stages) above the A₁ transformation temperature. The A₁ transformation temperature is the temperature at which the ferritic phase of the steel starts to transform into austenite. A first austenitization stage 80 temperature T₆ is higher than the temperature T₇ of a second austenitization stage 84. Each austenitization stage should be at least 30 minutes in duration Δt₃, Δt₄, and in some examples can range from 30 minutes to 300 minutes in duration Δt₃, Δt₄. The durations Δt₃, Δt₄ are inclusive of the heating time, holding time, and cooling time of the heating stage. In the heat treatment cycle 76 depicted in FIG. 4, both austenitization stages 80, 84 are also at a temperature above the A_{CM} temperature. The A_{CM} temperature is the temperature at which the ferritic phase of the steel is completely transformed into austenite. In the heat treatment cycle 76′ depicted in FIG. 5, the second austenitization stage 84′ is from the A₁ temperature to the A_{CM} temperature.

Typically, first austenitization stage 80 involves heating the steel to a temperature T₆ from 900 to 1100 degrees Celsius. During the first austenitization stage, at least some of the carbides or most of the carbides present in the steel are dissolved into the austenite phase of the component. After the first austenitization stage 80, the component is quenched to a temperature T₈ by air, an oil, a gas, or a liquid salt. The temperature T₈ is less than 500 degrees Celsius, but may alternatively b less than 300 degrees Celsius. The second austenitization stage 84 involves heating the steel to a temperature T₇ from 750 to 900 degrees Celsius followed by a quenching step. The second austenitization stage 84 determines the microstructure and involves either heating above A₁ or A_{CM} . As shown in FIG. 4, the second austenitization stage 84 has a temperature T₇ that is above the A_{CM} temperature. Heating the piece of steel to a temperature above the A_{CM} value results in the microstructure of the steel being fully austenite. The component undergoing the example cycle shown in FIG. 4 has been fully austenitized after the second austenitization stage 84. In the example shown in FIG. 5, the second austenitization stage 84′ has a temperature T₇′ that is from the A₁ to the A_{CM} temperatures. If the second austenitization stage 84 is from the A₁ to the A_{CM} temperature, the microstructure of the component is a combination of austenite and cementite.

After the second austenitization stage 84, 84′, the steel component is again quenched to a temperature T₉. The temperature T₉ of the second quench may be approximately martensite start temperature T_{MS}, depending on the desired microstructure. The temperature at which the steel is quenched after the second heating stage determines how much of the microstructure becomes martensite. The quench temperature is between 0.6*T_{MS} and 1.4*T_{MS}, but the range is preferably between 0.9*T_{MS} and 1.4*T_{MS}. In some cases, the range may be between 0.6*T_{MS} and 1.2*T_{MS}. Holding the component at the second quench temperature for a duration Δt₅ of at least 30 minutes results in bainite at the core of the component. In some examples, the duration Δt₅ is from 30 minutes to 240 minutes. The core of the component is defined as being at least 1000 micrometers below the surface of the component.

After the component is quenched and held for the duration of Δt₅, the component may then be heated and tempered 88 by raising the temperature. Tempering includes slightly reheating the component to a temperature T₁₀ and held for at least 5 minutes, then cooling the component slowly to room temperature. The temperature T₁₀ at least 5° C. higher than the T₉. Alternatively, component can be transferred to a salt bath or furnace that is at a temperature of T₁₀. Tempering also results in finer carbides, which leads to improved performance. After the tempering cycle 88, the component also has at least 15% retained austenite, but preferably at least 20% retained austenite. A through hardness of the steel component is at least 50 HRC, and may be between 55 to 65 HRC.

Although the invention has been described in detail with reference to certain preferred embodiments, variations and modifications exist within the scope and spirit of one or more independent aspects of the invention as described.

1-13. (canceled)

14. A method of through hardening steel with at least 0.7% weight of carbon, the method comprising:
heating a steel component to a first temperature;
quenching the steel component to a second temperature;
maintaining the steel component at the second temperature for a first time interval;
heating the steel component to a third temperature;
maintaining the steel component at the third temperature for a second time interval; and
quenching the steel component to a fourth temperature when austenite to martensite+bainite or bainite transformation is at least 20% but less than 80% complete;
wherein the steel component, after quenching to the fourth temperature, has a residual compressive stress of at least 100 MPA in a surface region of the steel component and
wherein the steel component, after quenching to the fourth temperature, includes at least 20% retained austenite.

15. The method of claim 14, wherein the first temperature is 800 degrees Celsius to 1100 degrees Celsius.

16. The method of claim 14, wherein the second temperature is from 0.6 times a martensite start temperature to 1.2 times the martensite start temperature.

17. The method of claim 14, wherein the third temperature is greater than the second temperature by at least 5 degrees Celsius.

18. The method of claim 17, wherein the third temperature is greater than the second temperature by no more than 200 degrees Celsius.

19. The method of claim 14, wherein the fourth temperature is equal to or less than 100 degrees Celsius.

20. The method of claim 14, wherein first time interval is from 20 minutes to 180 minutes.

21. (canceled)

22. The method of claim 14, wherein the second time interval is from 20 minutes to 180 minutes.

23. (canceled)

24. The method of claim 14, further including tempering the steel component after quench to the fourth temperature by reheating the steel component to a fifth temperature of 100 degrees Celsius to 350 degrees Celsius and quenching the component to an ambient temperature.

25. The method of claim 14, wherein the steel component, after quenching to the fourth temperature, has a through hardness of at least 50 HRC.

26. The method of claim 14, further comprising tempering the steel component after quenching to the fourth temperature, and wherein the steel component, after tempering, has a through hardness of at least 50 HRC.

27. The method of claim 14, wherein the steel component, after quenching to the fourth temperature, has a microstructure of at least 30% martensite in a surface region of the steel component and a microstructure of at least 30% bainite in a core of the steel component.

28. (canceled)

29. The method of claim 14, wherein the steel component is quenched to the fourth temperature when austenite to martensite+bainite or bainite transformation is at least 20% but less than 65% complete.

30. A steel component comprising a surface, a core, and a surface region extending from the surface toward the core to a depth up to 1000 micrometers below the surface:
an overall microstructure of the steel component including at least 20% retained austenite;
the core of the steel component having a microstructure including at least 30% bainite; and
the surface region of the steel component having a microstructure including at least 30% martensite, and wherein a through hardness of the steel component is at least 50 HRC;
wherein the surface region has a residual compressive stress of at least 100 MPa.

31. The steel component of claim 30, wherein the microstructure of the steel component includes less than 40% retained austenite.

32. The steel component of claim 30, wherein the core has a microstructure of at least 50% bainite.

33. The steel component of claim 30, wherein the surface region has a microstructure of at least 50% martensite.

34. (canceled)

35. The steel component of claim 30, wherein the microstructure between the surface region and the core is graded such that the microstructure gradually transforms from at least 30% martensite at the surface to at least 30% bainite at the core.

36-41. (canceled)
